(19) United States
(12) Patent Application Publication
(10) Pub. No.: US 2009/0328215 A1
(43) Pub. Date: Dec. 31, 2009

(54) SEMANTIC NETWORKS FOR INTRUSION DETECTION

(75) Inventors: Lior Arzi, Atlit (IL); Ron Karidi, Herzeliya (IL); Shai Aharon Rubin, Binyamina (IL); Efim Hudis, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/165,207

(22) Filed: Jun. 30, 2008

(51) Int. Cl. G06F 21/00

(52) U.S. Cl. 726/23

(57) ABSTRACT

Semantic networks are generated to model the operational behavior of an enterprise network to provide contextual interpretation of an event or a sequence of events that are observed in that specific enterprise network. In various illustrative examples, different semantic networks may be generated to model different behavior scenarios in the enterprise network. Without the context provided by these semantic networks malicious events may inherently be interpreted as benign events as there is typically always a scenario where such events could be part of normal operations of an enterprise network. Instead, the present semantic networks enable interpretation of events for a specific enterprise network. Such interpretation enables the conclusion that a sequence of events that could possibly be part of normal operations in a theoretical enterprise network is, in fact, abnormal for this specific enterprise network.

### BACKGROUND

Although the Internet has had great successes in facilitating communications between computer systems and enabling electronic commerce, the computer systems connected to the Internet have been under almost constant attack by hackers seeking to disrupt their operation. Many of the attacks seek to exploit vulnerabilities of the application programs or other computer programs executing on those computer systems. Different vulnerabilities can be exploited in different ways, such as by sending network packets, streaming data, accessing a file system, modifying registry or configuration data, and so on, which are referred to as security events. Developers of applications and administrators of enterprise networks commonly go to great effort and expense to identify and remove vulnerabilities because if a hacker identifies a vulnerability which is exploited, it can often result in significant negative consequences.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

Semantic networks are generated to model the operational behavior of an enterprise network to provide contextual interpretation of an event or a sequence of events that are observed in a specific enterprise network. A semantic network is a form of knowledge representation using a directed graph comprising vertices which represent concepts, and edges which represent relationships between the concepts. In various illustrative examples, different semantic networks may be generated to model different behavior scenarios in the enterprise network. Without the context provided by these semantic networks malicious events may inherently be interpreted as benign events as there is typically always a scenario where such events could be part of normal operations of an enterprise network. Instead, the present semantic networks enable interpretation of events for a specific enterprise network. Such interpretation enables the conclusion that an event sequence of events that could possibly be part of normal operations in a theoretical enterprise network is, in fact, abnormal for a specific enterprise network.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative enterprise network environment in which the present semantic network-based intrusion detection may be implemented;

FIG. 2 shows a current method for network-based intrusion detection in an enterprise network;

FIG. 3 shows an illustrative manner of characterizing an enterprise network using flat, fixed attributes;

FIG. 4 shows an illustrative general semantic network;

FIGS. 5 and 6 show illustrative vertices and edges that may be used specifically in semantic networks having applicability to enterprise networks scenarios;

FIG. 7 shows a flowchart of an illustrative method for enrichment of an attributes set used for interpreting events occurring in the network;

FIG. 8 shows vertices and edges used in a first illustrative scenario involving a reporting semantic network which models a reporting structure in an enterprise;

FIG. 9 shows the reporting semantic network;

FIG. 10 shows a table that indicates examples of use of the reporting semantic network to identify abnormal e-mail messages;

FIG. 11 shows vertices and edges used in a second illustrative scenario involving a logon times semantic network which models the likelihood a given user will logon to an enterprise network at a given time;

FIG. 12 shows the logon times semantic network;

FIG. 13 shows a table that indicates examples of use for the logon times semantic network to identify abnormal logon times;

FIG. 14 shows vertices and edges used in a third illustrative scenario involving a possession semantic network which models the connection between users, machines, and domains in an enterprise network;

FIG. 15 shows the possession semantic network; and

FIG. 16 shows a table that indicates examples of using the possession semantic network to identify abnormal logons of users to machines and/or domains.

Like reference numerals indicate like elements in the drawings.

### DETAILED DESCRIPTION

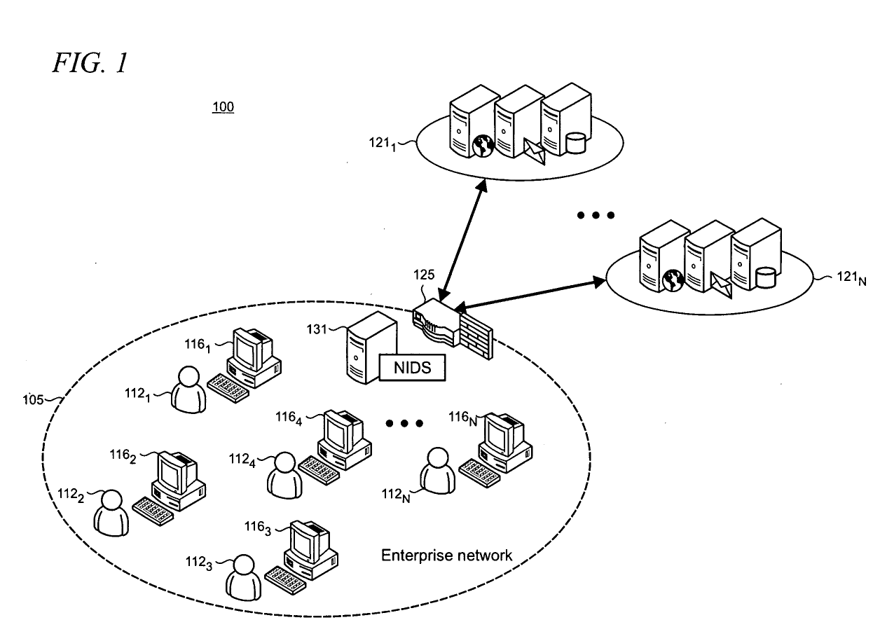

FIG. 1 shows an illustrative enterprise network environment 100 in which the present semantic network-based intrusion detection may be implemented. In the environment 100, an enterprise network 105 includes various users 112_{1,2 . . . N} who are associated with machines 116_{1,2 . . . N} such as personal computers (“PCs”), workstation, laptops and other types of information technology (“IT) assets. While the users 112 are shown as being mapped on a one-to-one basis in FIG. 1, this mapping is illustrative as users 112 may often be associated with more than one machine 116, and vice versa.

The enterprise network 105 is coupled to external networks to enable the users 112 and machines 116 to connect to various external resources 121_{1, 2, N} that may include web sites, databases, e-mail services, and the like. A firewall 125 and network intrusion detection system (“NIDS”) 131 are utilized, this example, to provide security protection for the users 112 and machines 116 in the enterprise network 105. The firewall 125 is typically located on the perimeter of the enterprise network 105 and monitors traffic flowing between the enterprise network and the external resources 121. The firewall 125 will commonly permit or block traffic in accordance with a rule set or policies.

The NIDS 131, if conventionally arranged, would perform intrusion detection to identify actions or events occurring in the enterprise network 105 that may be associated with a malicious attempt to compromise the confidentiality, integrity, or availability of a user 112 or machine 116 in the enterprise. While intrusion detection is shown as being performed at the network level (i.e., network-based intrusions detection) in FIG. 1, it may also be performed at the machine level (i.e., host-based intrusion detection).

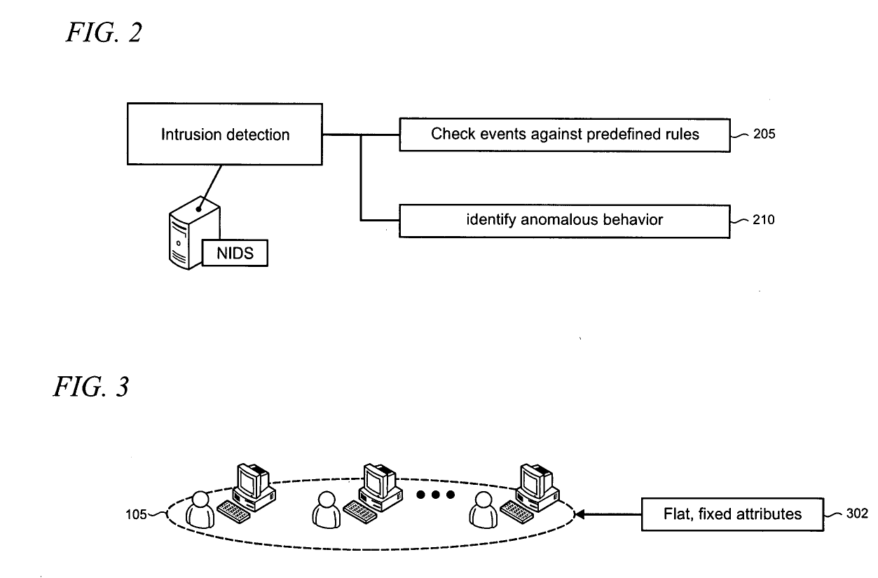

As shown in FIG. 2, intrusion detection is conventionally based on two primary approaches: a) checking events against a list of predefined rules (205); and b) identifying anomalous behavior (210). Conventional intrusion detection systems are known to have a high rate of false-positives (i.e., benign events that are incorrectly identified as intrusive). Efforts to reduce false-positive rates usually introduce a high rate of false-negative (i.e., intrusive events that are not detected as such). As shown in FIG. 3 current predefined rules characterize an enterprise network using flat, fixed attributes or metrics (as indicated by reference numeral 302) which are generally insufficient to enable the NIDS to separate “good” sequences of events from “bad” ones.

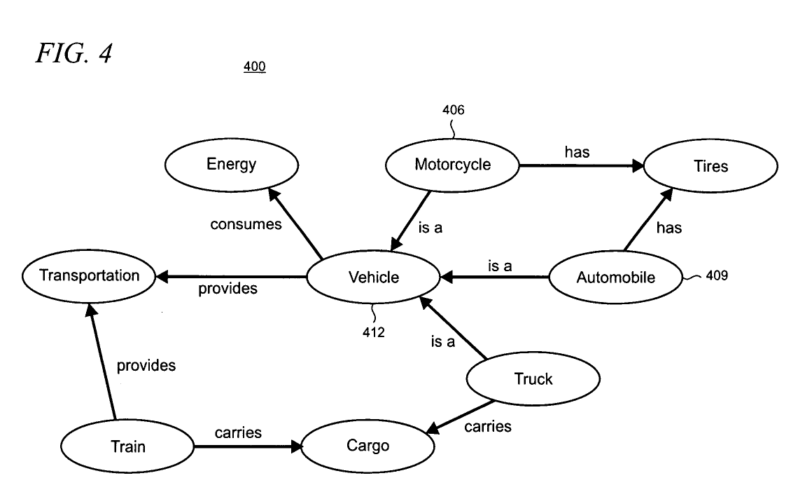

By comparison to the conventional use of flat, fixed attributes, the present semantic networks for intrusion detection uses an enriched set of attributes. A semantic network is often used as a form of knowledge representation. It is typically a directed graph consisting of vertices which represent concepts and edges which represent semantic relationships between the concepts. A generalized example of a semantic network 400 is shown in FIG. 4. As shown, for example, both the vertices “Motorcycle” 406 and “Automobile” 409 have the semantic relationship, or edge, “is a” with the vertex “Vehicle” 412.

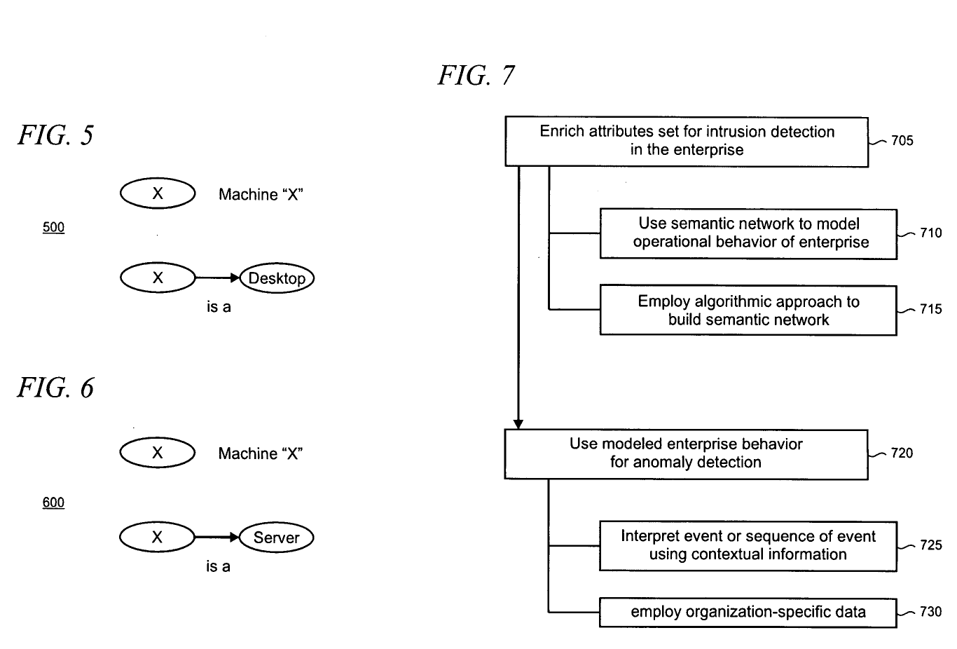

In the present case, FIGS. 5 and 6 show illustrative vertices and edges that may be used specifically in semantic networks having applicability to enterprise networks scenarios. Thus, for example, each machine 116 in the enterprise network 105 in FIG. 1 may be a vertex in the semantic network. Thus, a machine “X” can have an edge “is a” to the vertex “Desktop” (as indicated by reference numeral 500 in FIG. 5) or an edge “is a” to the vertex “Server” (as indicated by reference numeral 600 in FIG. 6).

FIG. 7 shows a flowchart of an illustrative method 700 for intrusion detection that may be performed using a semantic network. The steps include enrichment of the attributes set used for intrusion detection (705) by modeling various behaviors of an enterprise network as a semantic network (710) which may be performed through the application of one or more algorithms to generate the semantic network (715). Once the model is built, it may be then used for anomaly detection (720) through interpreting events occurring in the network (725) using enterprise-specific data (730).

Generally, application of this method may take into account events that occur in different levels of the enterprise. For example, a machine might indeed by suspicious if it sends out a lot of data from the network 105 to the external resources 121 and the machine is i) a desktop; ii) this desktop belong to a software developer who typically should not be sending data outside the network 105; iii) the origin of the data is a folder that contains sensitive information (e.g., program code of an upcoming product release); and iv) the destination for the data is a public e-mail account. By comparison, a machine that sends out a lot of data will not be deemed suspicious if the machine is i) a server; ii) the e-mail destination is at a legitimate business partner; and iii) the same data was sent to other partners as well.

The method shown in FIG. 7 may also generally take into account organization behavior when building attributes that are used for anomaly detection. Semantic networks can be built to model various aspects of such behavior.

The method 700 may be further illustrated using the scenarios described below.

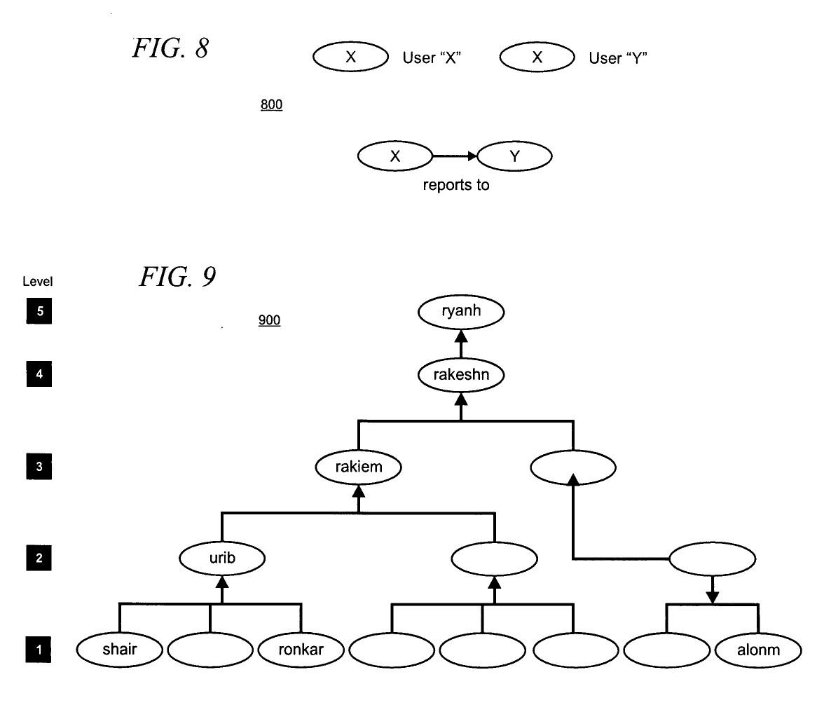

FIG. 8 shows vertices and edges used in a first illustrative scenario involving a reporting semantic network which models a reporting structure in an enterprise. Here, a vertex representing a user “X” has an edge “reports to” to the vertex “Y”, as indicated by reference numeral 800. The reporting semantic network 900 shown in FIG. 9 uses a tree-like graph to represent the reporting structure of users 112 in the enterprise network 105 that uses a hierarchical arrangement having five levels. In this example, the users 112 are identified by user names (which are sometimes referred to as “aliases”) in the semantic network 900. The number of edges between vertices represents a “reporting distance” in the hierarchy. Examination of the reporting semantic network 900 will show the following:
shair reports to urib
ronkar also reports to urib
urib reports to zakiem
The reporting distance between shair and zakiem is 2 (zakiem is in level 3 and shair is in level 1).
The reporting distance between shair and ryanh is 4.

The reporting semantic network 900 may be used, for example, to identify abnormal e-mail which is assumed to have potential for spreading malicious software (i.e., “malware”). Generally, once a suspicious e-mail is identified, it can be examined more closely to determine if it contains malware in fact.

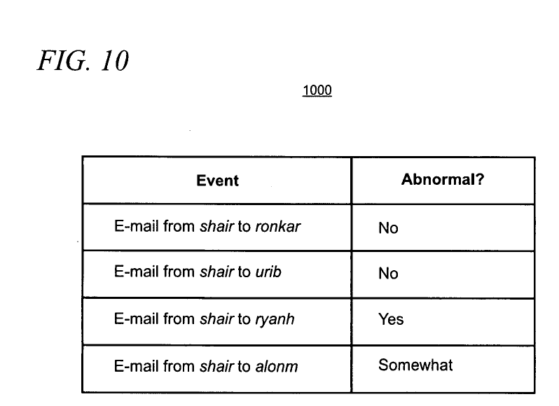

FIG. 10 shows a table 1000 that indicates examples of using the reporting semantic network to identify abnormal e-mail messages. An e-mail message from shair to ronkar will not be considered abnormal because these users both report to the same manager urib, so it is probable that they will regularly exchange e-mail. Similarly, as urib is the manager of shair, an email from shair to urib will not be considered as abnormal.

By comparison, an e-mail from shair to ryanh is considered abnormal as the reporting distance between these users is 4. E-mails that span such a large reporting distance are extremely rare in the specific case of enterprise 105. Accordingly, the e-mail from shair to ryanh is suspicious and can be further examined as a source of potential malware, for example.

An e-mail from shair to alomn will be somewhat suspicious. The common vertex shared by these users is rakeshn at a reporting distance of 3. Shair and alomn are also separated from each other by a reporting distance of 3. Due to this distance, it is unlikely that shair and alomn will have too many things in common. However, the e-mail communication is less suspicious than the e-mail from shair to ryanh described above because both users are at the same level (level 1) in the reporting hierarchy. As a result, there is some expectation that shair and alomn might collaborate from time to time.

The above reasoning as to why one e-mail is normal but another is suspicious is intended only to be illustrative, and it is emphasized that the reporting hierarchy using a graph to build the reporting semantic network enables such type of reasoning to be formalized and extended, for example, using a computer program. These programs can apply various algorithms to enable semantic networks to be built and used to provide contextual information in an automated manner for a wide variety of intrusion detection scenarios.

The likelihood of an event (such as an e-mail message being sent between users) being deemed abnormal may also be expressed using a probability. For example, as shown in FIG. 10, e-mail can be expressed as “somewhat” or using other terms which indicate some level of uncertainty. The likelihood or confidence of a given identification is termed “Fidelity” here and can be expressed using terms such as “Low”, “Medium”, “High”, etc. Probability may also be more formally expressed using a number between 0 and 1 in some implementations.

Generally, the detection of abnormal behavior in the enterprise network 105 may be enhanced by cross-referencing between several semantic networks. That is, semantic networks can provide contextual meaning for a variety of behaviors and organizational characteristics of a given enterprise. For example, and not by way of limitations, semantic networks can cover geographic organization (i.e., where users, machines, subnets, domains, etc.) are physically located, project team organization (which users, development groups, support organizations, etc. are involved with a particular project), time-based plans (what is planned to occur in an enterprise and when), and so on.

Several more illustrative examples of other semantic networks are discussed below.

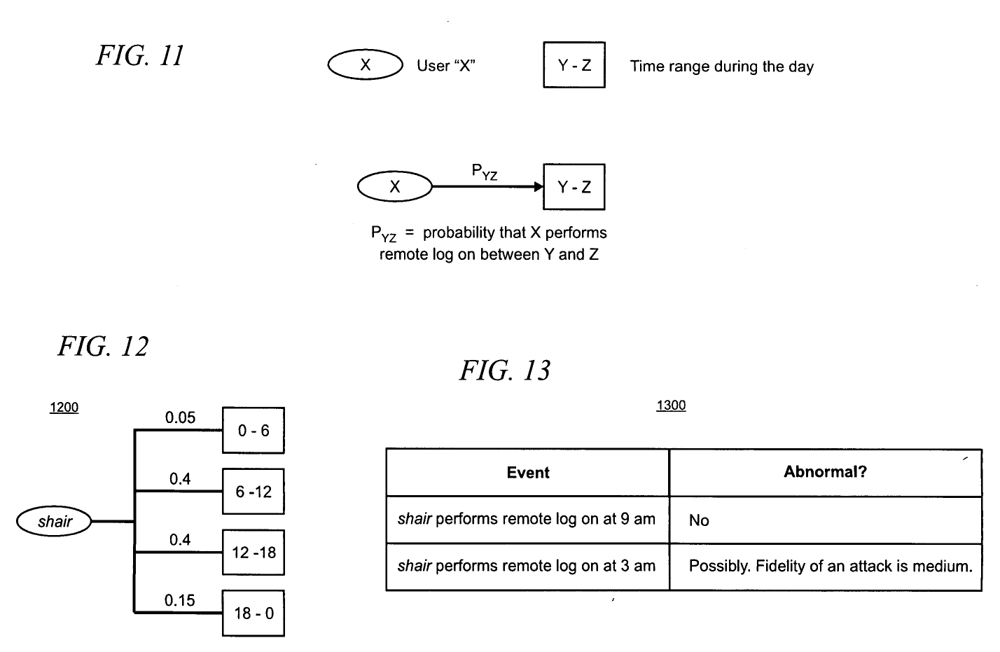

FIG. 11 shows vertices and edges used in a second illustrative scenario of a logon times semantic network which models the likelihood a given user will logon to an enterprise network 105 at a given time. As indicated by reference numeral 1100, a vertex representing a user “X” has an edge representing the probability P_{YZ} that the user “X” will perform a remote logon to a machine 116 the enterprise network 105 between the times of “Y-Z”. The logon times semantic network 1200 shown in FIG. 12 uses a graph to represent the probability that the user shair will perform the remote logon during four different six-hour time intervals (i.e., between the hours of midnight and 6:00 am; 6:00 am to noon; noon to 6:00 pm, and then 6:00 pm to midnight). As shown, statistical data that is captured about shair's remote logon behavior indicate that the probability for these times periods are respectively 0.05, 0.4, 0.4, and 0.15.

Table 1300 in FIG. 13 indicates examples of using the logon times semantic network 1200 to identify abnormal logon times. Shair performing a remote logon at 9 am in the morning, is not considered abnormal because this is during the beginning of the workday and shair often logs on during this time period. By comparison, a logon at 3 am is more suspicious. But it cannot be guaranteed that such logon is abnormal and indicative that is may associated with malicious activity because shair has logged in around that same time period in the past, and there could be a project with an upcoming deadline on which shair is working. Accordingly, the fidelity or confidence that the 3 am logon is suspicious is “medium”. If another semantic network covering open projects in the enterprise were built and available, then it could be used as a cross-reference to ascertain whether shair's remote logon at 3 am could indeed be related to an upcoming deadline. If so cross-referenced, then the 3 am logon could be eliminated altogether as suspicious, for example.

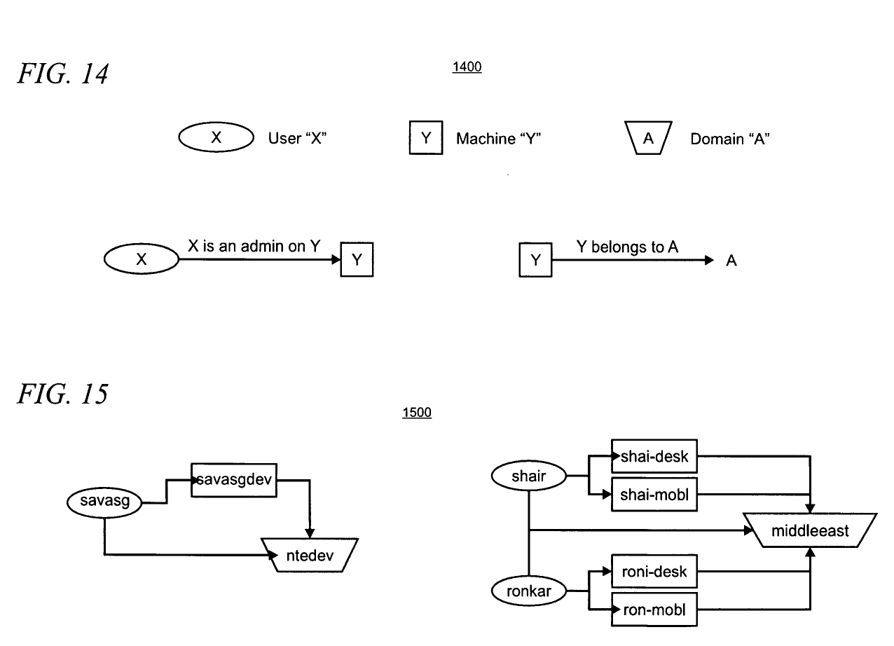

FIG. 14 shows vertices and edges used in a third illustrative example of a possession semantic network which models the connection between users “X”, machines “Y”, and domains “A” in the enterprise network 105, as indicated by reference numeral 1400. The possession semantic network 1500 in FIG. 15 uses several graphs to show that user savasg users the savasgdev machine in the ntdev domain while users shair and ronkar use several machines each (both desktop and mobile assets such as laptops PCs) that are coupled to the middleeast domain.

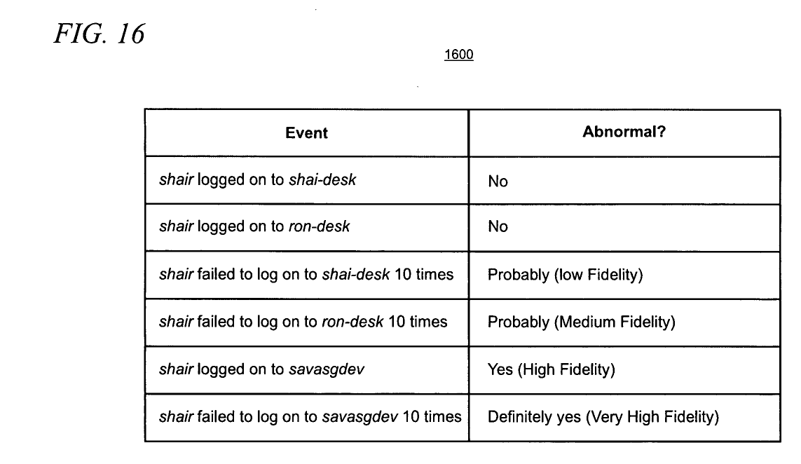

Table 1600 in FIG. 16 indicates examples of using the possession semantic network to identify abnormal logons of users to machines and/or domains. As shown, shair logging on to his desktop machine shai-desk is not deemed abnormal. Neither would shair logging onto the ron-desk machine as it likely that such logon means that shair is simply dealing with a work item that need to be performed. In addition, if the reporting semantic network 900 is cross-referenced, it would also be known that shair and ronkar are colleagues in the same organization which makes the shair's logon even less suspicious. Similarly, if a logon times semantic network is arranged to track the frequency of such logons and it is determined that shair is only logging on to ron-desk occasionally, this is further reinforcement that such logons are legitimately work-related and not malicious.

If shair fails to logon to the shai-desk desktop machine, then suspicion that such events are abnormal increases. The repeated logon failures could potentially indicate that the user attempting to logon is not, in fact, shair and/or shair's identity has been compromised in some way. As shown in table 1600, the characterization of the failed logon events uses the term probably (or may be expressed with a Low Fidelity) to reflect the likelihood that shai's logons are abnormal.

Using similar reasoning, the probability that the logons are abnormal and merit further investigation increases when shair repeatedly fails to logon to the ronkar-desk machine. Suspicion is increased, for example to Medium Fidelity, because the repeated failures occur on a machine that is not the user's own.

If shair attempts a logon to savasgdev, then the likelihood that this event is abnormal is even higher as shair and savasgdev are in two different domains where the usual interaction is very low. The view that such a logon event is abnormal is reflected with High Fidelity, for example, as shown in Table 1600.

If shair fails to logon to savasgdev after 10 attempts, then it may be very likely (i.e., Very High Fidelity) that such event is abnormal and could be malicious. Not only are the user and machine in different domains which normally have low interaction, but the inability to logon suggests that the user does not have the correct credentials.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for performing intrusion detection in an enterprise network, the method comprising the steps of:
modeling behavior of the enterprise network using one or more semantic networks, the one or more semantic networks each being arranged as a graph having a plurality of vertices and edges, the vertices representing concepts in the enterprise network and the edges representing relationships between the concepts; and
using the modeled behavior to detect anomalous events in the enterprise network by using contextual information provided by the one or more semantic networks to interpret an event or a sequence of events that occur in the enterprise network.

2. The method of claim 1 including a further step of configuring the one or more semantic networks for using enterprise-specific data in the modeled behavior.

3. The method of claim 1 as performed by a network-based intrusion detection system.

4. The method of claim 1 in which the network-based intrusion detection system is incorporated in a NIDS security product.

5. The method of claim 1 as performed by a host-based intrusion detection system.

6. A computer-implemented method for performing intrusion detection in an enterprise network, the method comprising the steps of:
implementing one or more algorithms for modeling behavior of the enterprise network using one or more semantic networks, the one or more semantic networks each being arranged as a graph having a plurality of vertices and edges, the vertices representing concepts in the enterprise network and the edges representing relationships between the concepts; and
using the modeled behavior to detect anomalous events in the enterprise network by using contextual information provided by the one or more semantic networks to interpret an event or a sequence of events that occur in the enterprise

7. The computer-implemented method of claim 6 in which the one or more semantic network comprise a reporting semantic network, the reporting semantic network being arranged to represent a hierarchical reporting relationships among a plurality of users in the enterprise network.

8. The computer-implemented method of claim 6 in which the one or more semantic network comprise a possession semantic network, the possession semantic network being arranged to represent relationships among a plurality of users, machines, and domains in the enterprise network.

9. The computer-implemented method of claim 6 in which the one or more semantic network comprise a logon times semantic network, the logon times semantic network being arranged to represent probabilities of logon of a user in the enterprise network.

10. The computer-implemented method of claim 6 including a further step of utilizing organization behavior for building attributes usable for anomaly detection.

11. The computer-implemented method of claim 6 in which the event is a security event or the sequence of events comprise a sequence of security events.
